(19) United States
(12) Patent Application Publication
(10) Pub. No.: US 2026/0267171 A1
(43) Pub. Date: Sep. 10, 2026

(54) THERMO-OPTIC PHASE SHIFTERS

(71) Applicant: GlobalFoundries U.S. Inc., Malta, NY (US)

(72) Inventor: Aneesh Dash, Bangalore (IN)

(21) Appl. No.: 19/073,196

(22) Filed: Mar. 7, 2025

(51) Int. Cl. G02F 1/01

(52) U.S. Cl. CPC G02F 1/0147; G02F 1/011; G02F 2202/104; G02F 2203/50

(57) ABSTRACT

Structures for a thermo-optic phase shifter and methods of forming such structures. The structure comprises a waveguide core including a section, a first layer including a first portion that overlaps with the section of the first waveguide core, and a second layer on a second portion of the first layer. The first layer comprises boron nitride, and the second layer comprises a conductor.

### BACKGROUND

The disclosure relates to photonic chips and, more specifically, to structures for a thermo-optic phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is transferred to the waveguide core, which is comprised of a material having a refractive index that varies with temperature. The efficiency of conventional thermo-optic phase shifters is limited by the ability to efficiently transfer heat.

Improved structures for a thermo-optic phase shifter and methods of forming such structures are needed.

### SUMMARY

In an embodiment of the invention, a structure for a thermo-optic phase shifter is provided. The structure comprises a waveguide core including a section, a first layer including a first portion that overlaps with the section of the first waveguide core, and a second layer on a second portion of the first layer. The first layer comprises boron nitride, and the second layer comprises a conductor.

In an embodiment of the invention, method of forming a structure for a thermo-optic phase shifter is provided. The method comprises forming a waveguide core including a section, forming a first layer including a first portion that overlaps with the section of the first waveguide core, and forming a second layer on a second portion of the first layer. The first layer comprises boron nitride, and the second layer comprises a conductor.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with alternative embodiments of the invention.

FIG. 5 is a cross-sectional view of a structure in accordance with alternative embodiments of the invention.

FIG. 6 is a cross-sectional view of a structure in accordance with alternative embodiments of the invention.

FIG. 7 is a cross-sectional view of a structure in accordance with alternative embodiments of the invention.

FIG. 8 is a cross-sectional view of a structure in accordance with alternative embodiments of the invention.

FIG. 9 is a cross-sectional view of a structure in accordance with alternative embodiments of the invention.

FIG. 10 is a cross-sectional view of a structure in accordance with alternative embodiments of the invention.

FIG. 11 is a cross-sectional view of a structure in accordance with alternative embodiments of the invention.

FIG. 12 is a cross-sectional view of a structure in accordance with alternative embodiments of the invention.

FIG. 13 is a top view of a structure in accordance with alternative embodiments of the invention.

FIG. 14 is a cross-sectional view of a structure in accordance with alternative embodiments of the invention.

### DETAILED DESCRIPTION

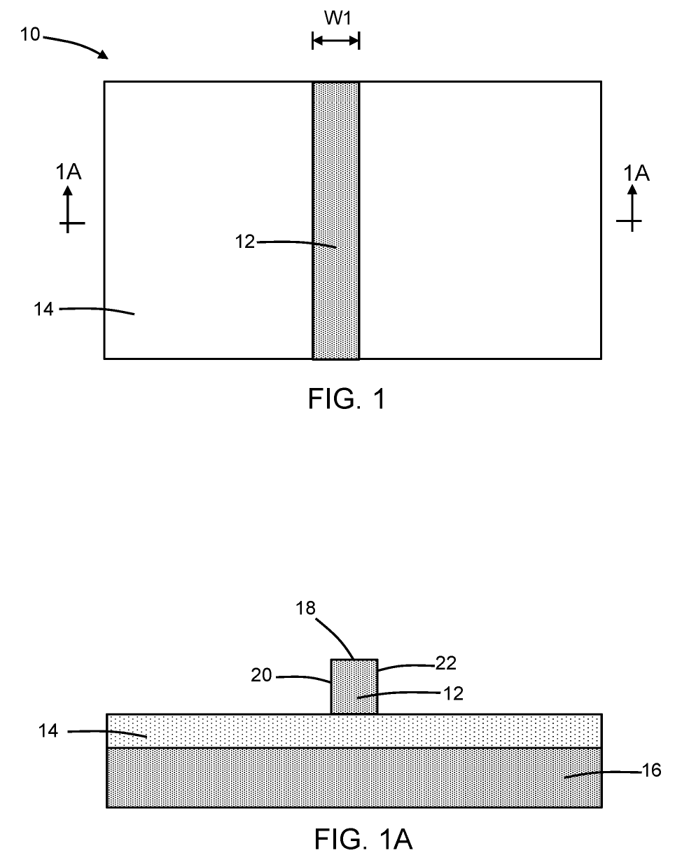

With reference to FIGS. 1, 1A and in accordance with embodiments of the invention, a structure 10 for a thermo-optic phase shifter includes a waveguide core 12 that is disposed on, and overlies, a dielectric layer 14 and a semiconductor substrate 16. In an embodiment, the dielectric layer 14 may be comprised of a dielectric material, such as an oxide like silicon dioxide, and the semiconductor substrate 16 may be comprised of a semiconductor material, such as single-crystal silicon. In an embodiment, the dielectric layer 14 may be a buried oxide layer of a silicon-on-insulator substrate.

The waveguide core 12 includes an upper surface 18, a lower surface that adjoins the dielectric layer 14 and that is opposite from the upper surface 18, a side surface 20, and a side surface 22 opposite from the side surface 20. The upper surface 18 is positioned between, and connects, the side surface 20 and the side surface 22. The waveguide core 12 has a width W1 between the side surface 20 and the side surface 22 that may be equal to the width of the upper surface 18.

In an embodiment, the waveguide core 12 may be comprised of a material having a refractive index that is greater than the refractive index of silicon dioxide. In an embodiment, the waveguide core 12 may be comprised of a semiconductor material, such as silicon. In an alternative embodiment, the waveguide core 12 may be comprised of a dielectric material, such as silicon nitride, silicon oxynitride, or aluminum nitride. In alternative embodiments, other materials, such as a polymer, diamond, thin-film lithium niobate, boron nitride, barium titanate, or a III-V compound semiconductor, may be used to form the waveguide core 12.

In an embodiment, the waveguide core 12 may be formed by depositing a layer comprised of its constituent material and patterning the deposited layer with lithography and etching processes. In an alternative embodiment, a thin slab layer may be connected to a lower portion of the waveguide core 12 to provide a rib waveguide. In an alternative embodiment, the waveguide core 12 may be configured as a slotted waveguide.

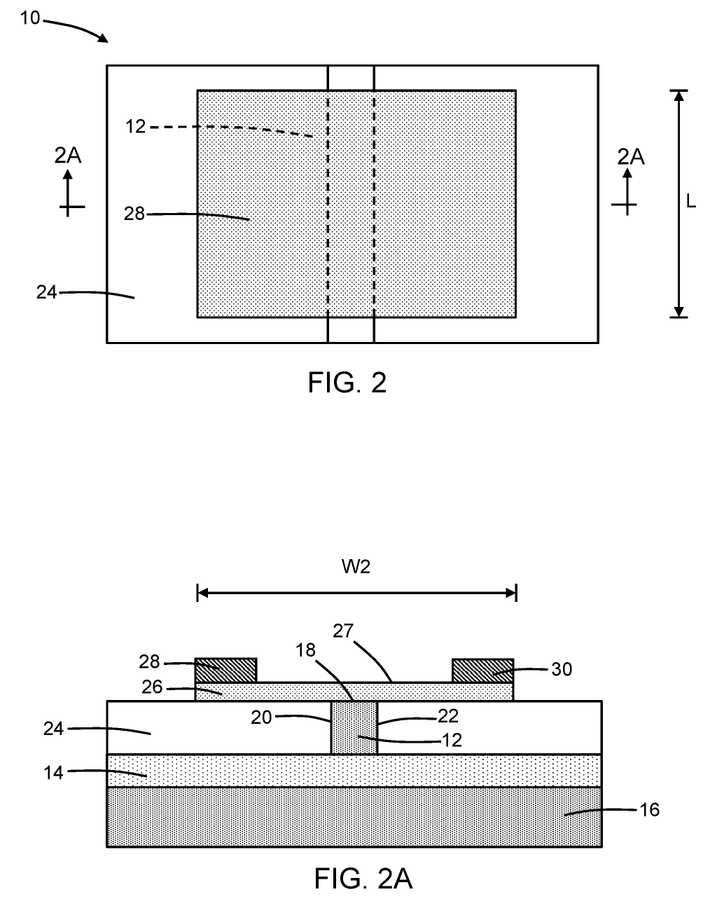

With reference to FIGS. 2, 2A in which like reference numerals refer to like features in FIGS. 1, 1A and at a subsequent fabrication stage, a dielectric layer 24 may be formed that surrounds the waveguide core 12. The dielectric layer 24 may be comprised of a dielectric material, such as silicon dioxide, having a refractive index that is less than the refractive index of the material constituting the waveguide core 12. The dielectric layer 24 may be deposited and planarized. In an embodiment, the dielectric layer 24 may have an upper surface that is coplanar with the upper surface 18 of the waveguide core 12.

A layer 26 may be formed on, and that overlies, the upper surface 18 of a section of the waveguide core 12. In an embodiment, the layer 26 may fully overlap with the upper surface 18 of the section of the waveguide core 12. In an embodiment, the layer 26 may adjoin and directly contact the upper surface 18 of the section of the waveguide core 12. The waveguide core 12 may include sections that project lengthwise beyond opposite side edges of the layer 26, as best shown in FIG. 2, and these non-overlaid sections may be coupled to photonic components of the photonic integrated circuit. The waveguide core 12 is arranged in a vertical direction between the layer 26 and the semiconductor substrate 16.

The layer 26 may be comprised of a material having a higher thermal conductivity than the dielectric material of the dielectric layer 24. The layer 26 may be comprised of a material that is an electrical insulator and that has a higher thermal conductivity than the dielectric material of the dielectric layer 24. In an embodiment, the layer 26 may be comprised of boron nitride. In an embodiment, the layer 26 may be comprised of a material having a thermal conductivity that is anisotropic. In an embodiment, the layer 26 may be comprised of boron nitride characterized by a hexagonal crystal structure for which the thermal conductivity is anisotropic and that is optically transparent at wavelengths of interest in photonics applications.

Layers 28, 30 may be coupled to opposite edge portions of the layer 26. The layers 28, 30 may overlie the respective edge portions of the layer 26. In an embodiment, the layers 28, 30 may adjoin and directly contact a top surface 27 of the layer 26. The waveguide core 12 may be positioned in a lateral direction between the layer 28 and the layer 30. The layer 26 represents a thermally-conductive bridge connecting the layers 28, 30 to the waveguide core 12. The waveguide core 12 is positioned in a lateral direction between the layer 28 and the layer 30. In an embodiment, the waveguide core 12 may be centered in a lateral direction between the layer 28 and the layer 30.

In an embodiment, the layers 28, 30 may be comprised of a conductor. In an embodiment, the layers 28, 30 may be comprised of a metal, such as copper. In an alternative embodiment, the layers 28, 30 may be comprised of a doped semiconductor material, such as doped polysilicon. In an embodiment, the layers 28, 30 may be formed by deposition, lithography, and etching processes.

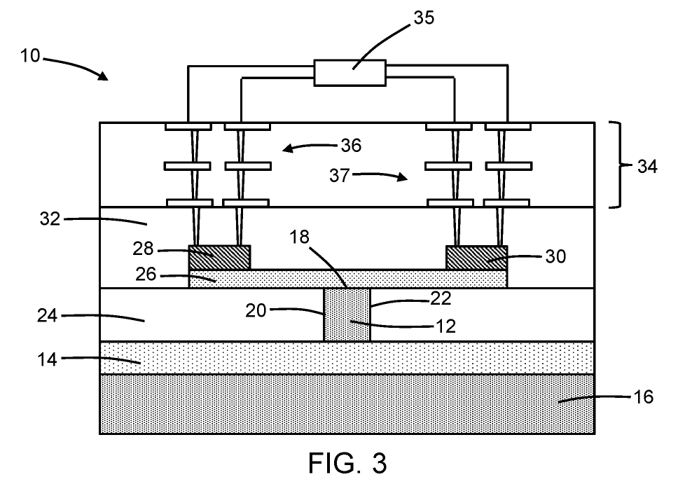

With reference to FIG. 3 which like reference numerals refer to like features in FIGS. 2, 2A and at a subsequent fabrication stage, a dielectric layer 32 may be formed that overlies the layer 26. The dielectric layer 32 may be comprised of a dielectric material, such as silicon dioxide, having a refractive index that is less than the refractive index of the material constituting the layer 26. The dielectric material of the dielectric layer 32 may be characterized by a lower thermal conductivity than the material of the layer 26.

A back-end-of-line stack 34 may overlie the dielectric layer 32. The back-end-of-line stack 34 may include dielectric layers and interconnects 36, 37 in the dielectric layers that are coupled by contacts in the dielectric layer 32 to the layers 28, 30. The dielectric layers of back-end-of-line stack 34 may each be comprised of a dielectric material, such as silicon dioxide, silicon nitride, tetraethylorthosilicate silicon dioxide, or fluorinated-tetraethylorthosilicate silicon dioxide. The interconnects 36, 37 may be comprised of a metal, such as copper or aluminum, and may include connected vias and wires arranged in multiple metallization levels of the back-end-of-line stack 34.

In an embodiment, the interconnects 36, 37 may couple the layers 28, 30 to a power supply 35 such that the layers 28, 30 may function as heaters. For example, the power supply 35 may be operated to supply a current that causes Joule heating of the layers 28, 30. The layer 26 conducts the heat from the layers 28, 30 to the section of the waveguide core 12 underlying the layer 26, which may raise the temperature of the section of the waveguide core 12 underlying the layer 26. In an alternative embodiment, the interconnects 36, 37 may function as a heat sink heat can be extracted from the layer 26. The extracted heat may lower the temperature of the section of the waveguide core 12 underlying the layer 26.

In use, the waveguide core 12 may guide propagating light such that the highest optical intensity region of the optical mode is associated within the waveguide core 12 and immediately adjacent to the surfaces 18, 20, 22 of the waveguide core 12. Heat may be generated by the layers 28, 30 and transferred from the layers 28, 30 by the layer 26 to the section of the waveguide core 12 underlying the layer 26. The temperature of the section of the waveguide core 12 underlying the layer 26 is elevated by the transferred heat, which is effective to change the refractive index of the material of the waveguide core 12 and thereby change the phase of the propagating light.

The layer 26 may enable efficient transfer of heat between the waveguide core 12 and the layers 28, 30 in comparison with a conventional thermo-optic phase shifter. The greater heat transfer efficiency may enable efficient thermal tuning of light propagating in the heated section of the waveguide core 12. The layer 26 may enable more uniform heating of the waveguide core 12 in comparison with a conventional thermo-optic phase shifter and the properties may be engineered to produce a higher temperature in comparison with conventional thermo-optic phase shifters. The thermal transient may be faster in comparison with a conventional thermo-optic phase shifter due to the high thermal conductivity of the material of the layer 26.

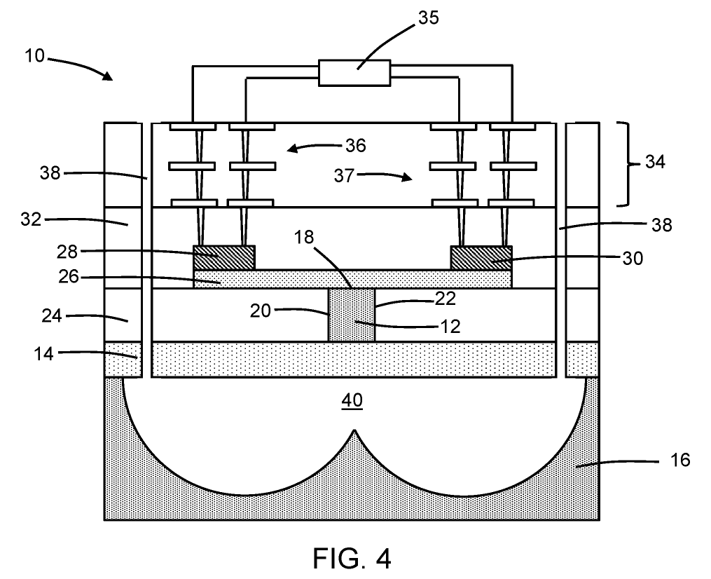

With reference to FIG. 4 and in accordance with alternative embodiments, the structure 10 may include trenches 38 that extend through the back-end-of-line stack 34, the dielectric layer 32, the dielectric layer 24, and the dielectric layer 14 to an undercut 40 in the semiconductor substrate 16. The trenches 38 and the undercut 40 may be formed by lithography and etching processes. In an embodiment, the trenches 38 and the undercut 40 may be filled by air or a different gas with a low thermal conductivity. The trenches 38 and the undercut 40 may function to provide thermal isolation.

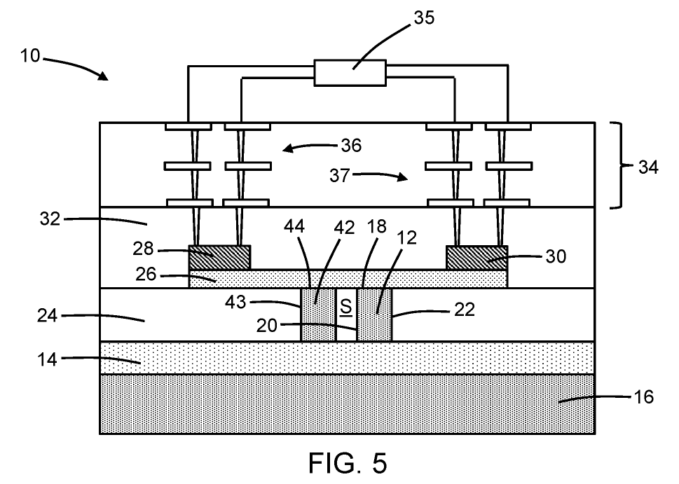

With reference to FIG. 5 and in accordance with alternative embodiments, the structure 10 may include a waveguide core 42 that has a section overlaid by the layer 26 and that is arranged adjacent to the section of the waveguide core 12 overlaid by the layer 26. In an embodiment, the layer 26 may overlap with an upper surface 44 of the section of the waveguide core 42, as well as overlap with the upper surface 18 of the section of the waveguide core 12. In an embodiment, the layer 26 may include a portion that adjoins and directly contacts the upper surface 18 of the overlaid section of the waveguide core 12 and a portion that adjoins and directly contacts the upper surface 44 of the overlaid section of the waveguide core 42. The waveguide core 42 may have a side surface 43, as well as a side surface that is opposite from the side surface 43 and that is adjacent to the side surface 20 of the waveguide core 12.

The waveguide core 12 and the waveguide core 42 effectively represent a slotted waveguide core with a slot between the waveguide core 12 and the waveguide core 42. The slot S between the waveguide core 12 and the waveguide core 42 may be filled by an air gap or, alternatively, by a dielectric material. In an alternative embodiment, an additional waveguide core having a section adjacent to the sections of the waveguide core 12 and the waveguide core 42 such that a slotted waveguide core with multiple slots is formed.

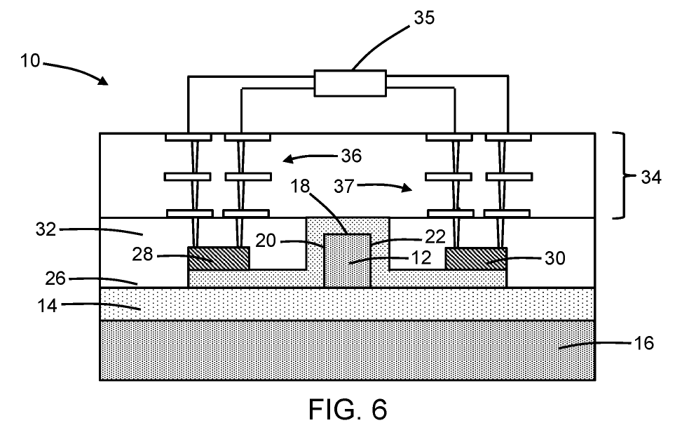

With reference to FIG. 6 and in accordance with alternative embodiments, the layer 26 may partially surround the overlaid section of the waveguide core 12. In an embodiment, the layer 26 may wrap around the upper surface 18 and the side surfaces 20, 22 of the overlaid section of the waveguide core 12. In an embodiment, the layer 26 may adjoin and directly contact the upper surface 18 and the side surfaces 20, 22 of the overlaid section of the waveguide core 12. In an embodiment, the layer 26 may be characterized by a conformal layer thickness. In an alternative embodiment in which a slab layer is coupled to a lower portion of the overlaid section of the waveguide core 12, the layer 26 may also conformally coat the slab layer.

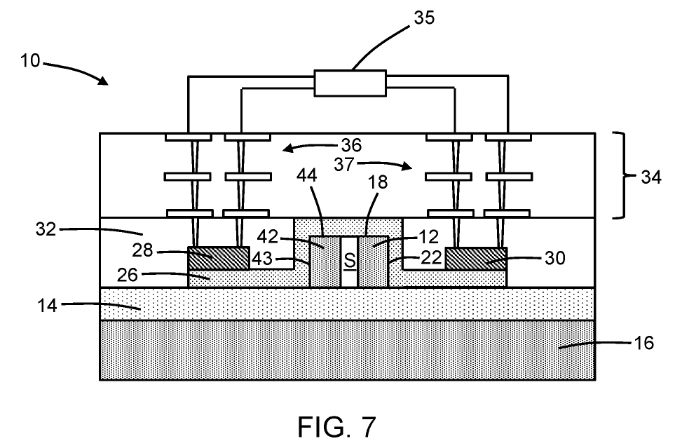

With reference to FIG. 7 and in accordance with alternative embodiments, the layer 26 may partially surround the overlaid section of the waveguide core 12 and the overlaid section of the waveguide core 42. In an embodiment, the layer 26 may wrap around the overlaid section of the waveguide core 12 and the overlaid section of the waveguide core 42. In an embodiment, the layer 26 may directly contact the upper surface 18 and the side surface 22 of the waveguide core 12, as well as directly contact the upper surface 44 and the side surface 43 of the waveguide core 42. In an embodiment, the layer 26 may be characterized by a conformal layer thickness.

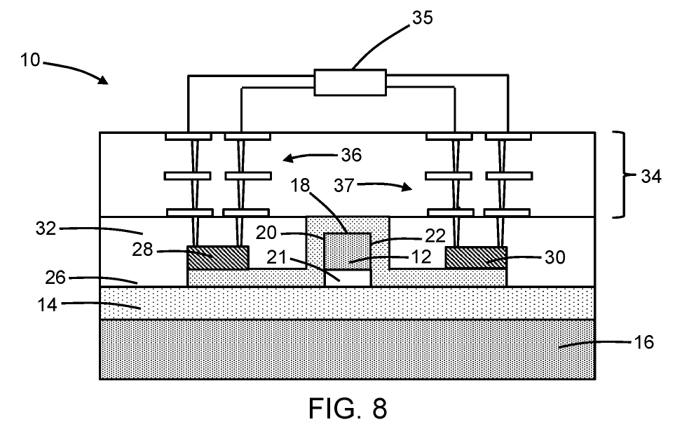

With reference to FIG. 8 and in accordance with alternative embodiments, the waveguide core 12 may be spaced in a vertical direction from the dielectric layer 14. A layer 21 may be arranged in the space between the waveguide core 12 and the dielectric layer 14. The layer 21 may be comprised of a dielectric material, such as silicon dioxide or silicon nitride.

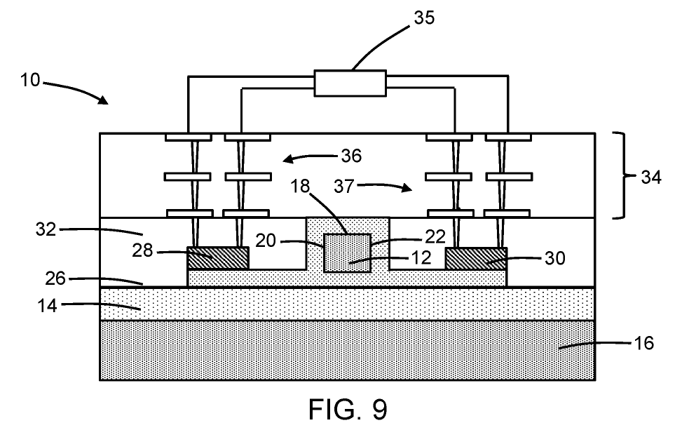

With reference to FIG. 9 and in accordance with alternative embodiments, the layer 26 may fully surround the overlaid section of the waveguide core 12. In an embodiment, the layer 26 may wrap around the overlaid section of the waveguide core 12. In an embodiment, the layer 26 may adjoin and directly contact the upper surface 18, the lower surface, and both side surfaces 20, 22 of the waveguide core 12. A portion of the layer 26 may be deposited on the dielectric layer 14 before the waveguide core 12 is formed. In an embodiment, the layer 26 may be characterized by a conformal layer thickness.

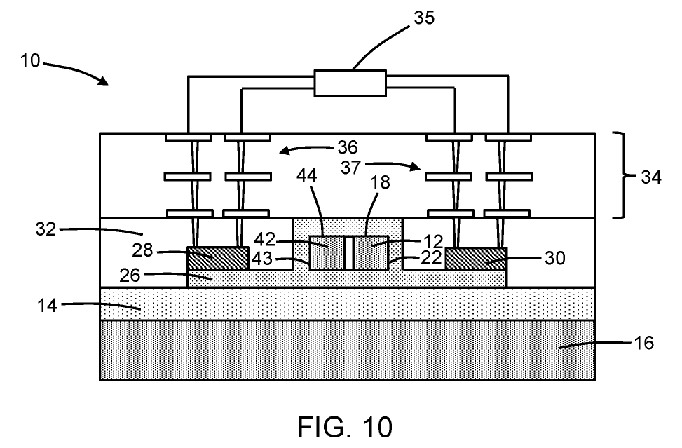

With reference to FIG. 10 and in accordance with alternative embodiments, the layer 26 may fully surround the overlaid section of the waveguide core 12 and the overlaid section of the waveguide core 42. In an embodiment, the layer 26 may wrap around the overlaid section of the waveguide core 12 and the overlaid section of the waveguide core 42. In an embodiment, the layer 26 may adjoin and directly contact the upper surface 18, the lower surface, and the side surface 22 of the waveguide core 12, and the layer 26 may also adjoin and directly contact the upper surface 44, the lower surface, and the side surface 43 of the waveguide core 42. A portion of the layer 26 may be deposited on the dielectric layer 14 before the waveguide core 12 and the waveguide core 42 are formed. In an embodiment, the layer 26 may be characterized by a conformal layer thickness.

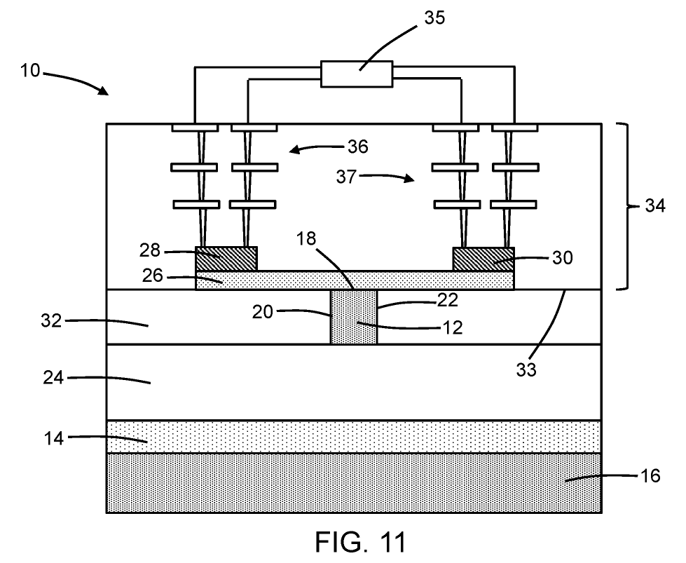

With reference to FIG. 11 and in accordance with alternative embodiments, the layer 26 may be positioned in the back-end-of-line stack 34 that is formed over the dielectric layer 32. In that regard, the waveguide core 12 may be positioned on the dielectric layer 24, the layer 26 may be positioned on the dielectric layer 32, and the layer 26 may overlap with an underlying section of the waveguide core 12. The back-end-of-line stack 34 may adjoin the dielectric layer 32 along an interface 33, and the layer 26 and the waveguide core 12 may be arranged on opposite sides of the interface 33. For example, the layer 26 may be considered to be arranged above the interface 33 and the waveguide core 12 may be considered to be arranged above the interface 33.

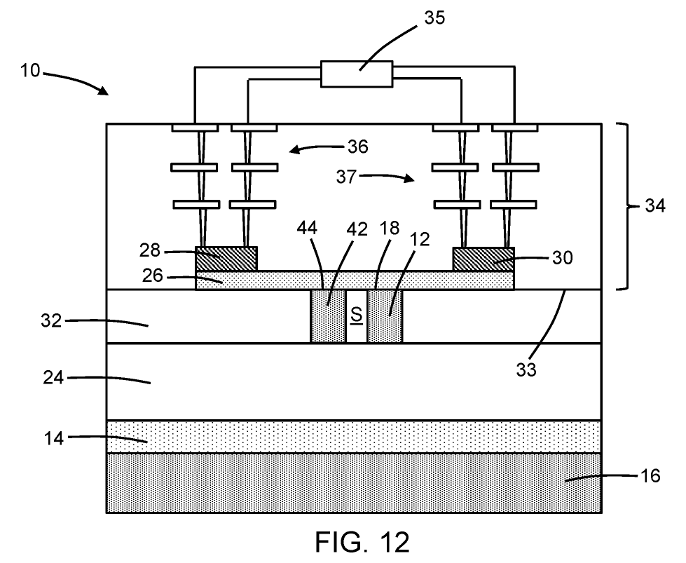

With reference to FIG. 12 and in accordance with alternative embodiments, the layer 26 may be positioned in the back-end-of-line stack 34 that is formed over the dielectric layer 32. In that regard, the waveguide core 12 and the waveguide core 42 may be positioned on the dielectric layer 24, the layer 26 may be positioned on the dielectric layer 32, and the layer 26 may overlap with an underlying section of the waveguide core 12 and an underlying section of the waveguide core 42. The back-end-of-line stack 34 may adjoin the dielectric layer 34 along an interface 33, and the layer 26 and the waveguide cores 12, 42 may be arranged in a vertical direction on opposite sides of the interface 33. For example, the layer 26 may be considered to be arranged above the interface 33 and the waveguide cores 12, 42 may be considered to be arranged above the interface 33.

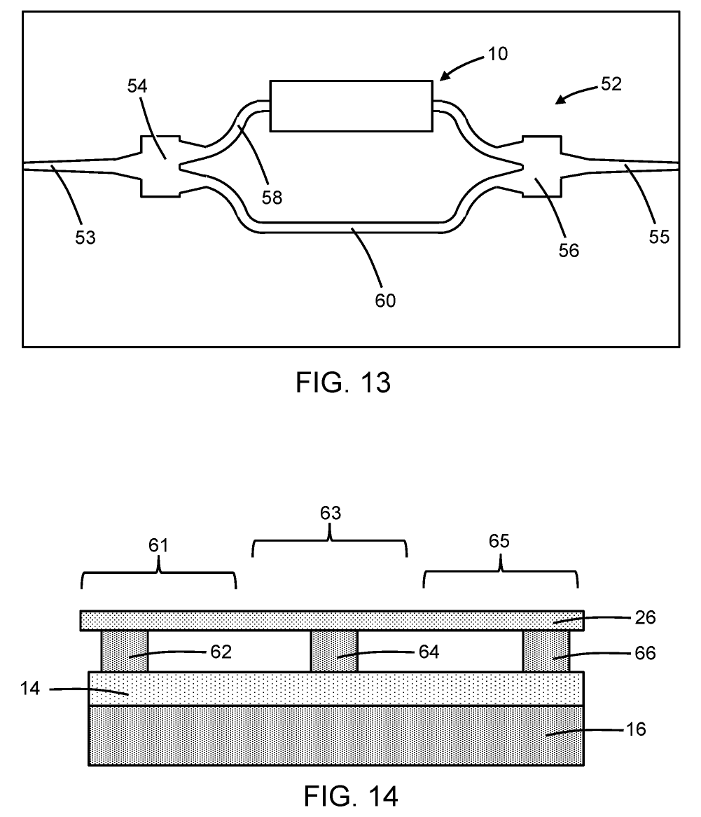

With reference to FIG. 13 and in accordance with alternative embodiments, a Mach-Zehnder interferometer 52 includes an input optical coupler 54, an output optical coupler 56, and waveguide cores 58, 60 defining arms that are separately routed from the input optical coupler 54 to the output optical coupler 56. An input waveguide core 53 is coupled to the input optical coupler 54, and an output waveguide core 55 coupled to the output optical coupler 56. One of the arms of the Mach-Zehnder interferometer 52 may integrate a thermo-optic phase shifter embodied in the structure 10. The thermo-optic phase shifter may be used to generate a phase difference between the light propagating in the arms represented by the waveguide cores 58, 60 of the Mach-Zehnder interferometer 52. The phase difference may be achieved through generating heat by energizing the layers 28, 30 and transferring the heat by conduction through the layer 26 to the overlaid section of the waveguide core 12 in the thermo-optic phase shifter.

In an alternative embodiment, the structure 10 may be integrated into a micro-ring resonator. In an alternative embodiment, the structure 10 may be integrated into a ring-assisted Mach-Zehnder interferometer.

With reference to FIG. 13 and in accordance with alternative embodiments, the layer 26 may also be utilized to connect optically separated functional blocks 61, 63, 65 of devices, circuits, or systems as a thermal bridge providing a pathway for thermal conduction. The layer 26 may be employed to maintain multiple devices, multiple circuits, or multiple systems at similar temperatures by distributing heat between the functional blocks 61, 63, 65. In an embodiment, the layer 26 may be isothermally coupled to a waveguide core 62 of a Mach-Zehnder interferometer in the functional block 61, a waveguide core 64 of a Mach-Zehnder interferometer in the functional block 63, and a waveguide core 66 of a Mach-Zehnder interferometer in the functional block 65.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/- 10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers all or a part of, another feature. A feature may “overlie” another feature if the feature is positioned in elevation over another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a thermo-optic phase shifter, the structure comprising:
a first waveguide core including a first section;
a first layer including a first portion and a second portion, the first portion of the first layer overlapping with the first section of the first waveguide core, and the first layer comprising boron nitride; and
a second layer on the second portion of the first layer, the second layer comprising a conductor.

2. The structure of claim 1 wherein the boron nitride has a hexagonal crystal structure.

3. The structure of claim 1 wherein the conductor of the second layer comprises a metal or doped polycrystalline silicon.

4. The structure of claim 1 wherein the first waveguide core has a first side surface, a second side surface, and an upper surface, and the first portion of the first layer adjoins the upper surface.

5. The structure of claim 1 wherein the first waveguide core has a first side surface, a second side surface, and an upper surface, and the first portion of the first layer adjoins the upper surface, the first side surface, and the second side surface.

6. The structure of claim 1 wherein the first waveguide core includes a plurality of surfaces, and the second layer fully surrounds the plurality of surfaces of the first waveguide core.

7. The structure of claim 6 wherein the second layer adjoins the plurality of surfaces of the first waveguide core.

8. The structure of claim 1 wherein the first layer includes a third portion, and further comprising:
a third layer on the third portion of the first layer, the third layer comprising the conductor; and
a back-end-of-line stack overlying the first layer, the back-end-of-line stack including a first interconnect coupled to the second layer and a second interconnect coupled to the third layer.

9. The structure of claim 1 further comprising:
a second waveguide core including a section adjacent to the first section of the first waveguide core,
wherein the first layer includes a third portion that overlaps with the section of the second waveguide core.

10. The structure of claim 9 wherein the first waveguide core has a first upper surface, the second waveguide core has a second upper surface, the first portion of the first layer adjoins the first upper surface, and the third portion of the first layer adjoins the second upper surface.

11. The structure of claim 9 wherein the first waveguide core has a first upper surface and a first side surface, the second waveguide core has a second upper surface and a second side surface, the first portion of the first layer adjoins the first upper surface and the first side surface, and the third portion of the first layer adjoins the second upper surface and the second side surface.

12. The structure of claim 9 wherein the first section of the first waveguide core and the section of the second waveguide core are separated by a slot.

13. The structure of claim 1 further comprising:
a back-end-of-line stack overlying the first waveguide core,
wherein the first layer is arranged in the back-end-of-line stack.

14. The structure of claim 13 further comprising:
a dielectric layer adjoining the back-end-of-line stack along an interface,
wherein the first waveguide core is positioned in the dielectric layer, and the first layer and the first section of the first waveguide core are arranged on opposite sides of the interface.

15. The structure of claim 13 further comprising:
a second waveguide core including a section adjacent to the first section of the first waveguide core,
wherein the first layer includes a third portion that overlaps with the section of the second waveguide core.

16. The structure of claim 15 further comprising:
a dielectric layer adjoining the back-end-of-line stack along an interface,
wherein the first waveguide core and the second waveguide core are positioned in the dielectric layer, the first layer and the first section of the first waveguide core are arranged on opposite sides of the interface, and the first layer and the section of the second waveguide core are arranged on opposite sides of the interface.

17. The structure of claim 16 wherein the first waveguide core has a first upper surface, the second waveguide core has a second upper surface, the first portion of the first layer adjoins the first upper surface, and the second portion of the first layer adjoins the second upper surface.

18. The structure of claim 1 further comprising:
a semiconductor substrate including a cavity beneath the first section of the first waveguide core,
wherein the first section of the first waveguide core is positioned between the cavity in the semiconductor substrate and the first layer.

19. The structure of claim 1 wherein the first waveguide core is included in a first functional block, and further comprising:
a second waveguide core in a second functional block, the second waveguide core including a section,
wherein the first layer includes a third portion that overlaps with the section of the second waveguide core.

20. A method of forming a structure for a thermo-optic phase shifter, the method comprising:
forming a waveguide core;
forming a first layer including a first portion that overlaps with a section of the waveguide core, wherein the first layer comprises boron nitride; and
a second layer on a second portion of the first layer, wherein the second layer comprises a conductor.
